(19) United States
(12) Patent Application Publication
(10) Pub. No.: US 2011/0230138 A1
(43) Pub. Date: Sep. 22, 2011

(54) ELECTRONIC DEVICE AND COMMUNICATION CONTROL METHOD

(75) Inventor: Hideki Ohkita, Kunitachi-shi (JP)

(73) Assignee: KABUSHIKI KAISHA TOSHIBA, Tokyo (JP)

(21) Appl. No.: 13/149,787

(22) Filed: May 31, 2011

Related U.S. Application Data
(63) Continuation of application No. 12/464,446, filed on May 12, 2009.

(30) Foreign Application Priority Data
Jul. 23, 2008 (JP) 2008-190023

(51) Int. Cl. H04B 7/00

(52) U.S. Cl. 455/41.2

(57) ABSTRACT

According to one embodiment, an electronic device comprises a close proximity wireless transfer device and a connection mode switching module. The close proximity wireless transfer device executes a close proximity wireless transfer. The connection mode switching module alternately switches, when the close proximity wireless transfer device is not connected to another close proximity wireless transfer device, a connection mode of the close proximity wireless transfer device between a first mode that requests connection to the other close proximity wireless transfer device and a second mode that detects a connection request from the other close proximity wireless transfer device.

### CROSS-REFERENCE TO RELATED APPLICATIONS

This application is a continuation of U.S. patent application Ser. No. 12/464,446, filed on May 12, 2009 and entitled “ELECTRONIC DEVICE AND COMMUNICATION CONTROL METHOD,” which is based upon and claims the benefit of priority from Japanese Patent Application No. 2008-190023, filed Jul. 23, 2008, the entire contents of both of which are incorporated herein by reference.

### BACKGROUND

1. Field

One embodiment of the invention relates to an electronic device which communicates by means of a close proximity wireless transfer method.

2. Description of the Related Art

In a close proximity wireless transfer method, when the user brings devices close to each other, the devices can communicate with each other. Since this operation is intuitive and simple for the user, the close proximity wireless transfer is promised to be widespread in portable terminal devices and the like in the future.

A device of the close proximity wireless transfer method needs to monitor proximity of another device so as to initiate communication by detecting proximity of the other device. For this purpose, the device of the close proximity wireless transfer method always consumes electric power. Since the device of the close proximity wireless transfer method is used in a portable terminal device or the like, and long-term continuous use is assumed, it is desired to reduce the power consumption as much as possible.

Jpn. Pat. Appln. KOKAI Publication No. 2005-142854 discloses the following communication apparatus. That is, in wireless communication between communication apparatuses, one of the communication apparatuses is defined as a master station, and the others are defined as slave stations. The master station as the transmitting side communicates with the slave stations as the receiving side. If a plurality of communication apparatuses that may serve as a master station exists, the communication apparatus comprises means for automatically switching the master and slave stations under a predetermined condition.

In order to establish connection between two devices based on the close proximity wireless transfer method, a certain device needs to transmit a connection request, and the other device needs to receive this connection request and to return a response. For this reason, upon establishing connection between the devices, the transmission and reception timings of the connection request in the two devices are important.

Therefore, in order to surely establish connection between devices, a new means for controlling the transmission and reception switching timings in each device needs to be implemented.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the arrangement of an electronic device according to an embodiment of the present invention;

FIG. 2 is an exemplary block diagram showing the configuration of a close proximity wireless transfer control program installed in the electronic device according to the embodiment;

FIG. 3 is an exemplary view for explaining an example of a close proximity wireless transfer using the electronic device according to the embodiment;

FIG. 4 is an exemplary view for explaining connection processing between two electronic devices based on a normal close proximity wireless transfer method;

FIG. 5 is an exemplary view for explaining an example of a connection processing failure between two electronic devices based on the normal close proximity wireless transfer method;

FIG. 6 is an exemplary view for explaining another example of a connection processing failure between two electronic devices based on the normal close proximity wireless transfer method;

FIG. 7 is an exemplary view for explaining connection mode switching based on constant durations in connection processing between two electronic devices according to the embodiment;

FIG. 8 is an exemplary view for explaining connection mode switching based on random numbers in connection processing between two electronic devices according to the embodiment;

FIG. 9 is an exemplary view for explaining an example of connection mode switching according to power supply states in connection processing between two electronic devices according to the embodiment;

FIG. 10 is an exemplary view for explaining another example of connection mode switching according to power supply states in connection processing between two electronic devices according to the embodiment;

FIG. 11 is an exemplary flowchart showing the procedure of connection mode switching processing based on constant durations in the electronic device according to the embodiment;

FIG. 12 is an exemplary flowchart showing the procedure of connection mode switching processing using durations based on random numbers in the electronic device according to the embodiment;

FIG. 13 is an exemplary flowchart showing the procedure of duration adjustment processing of connection mode switching based on power supply states in the electronic device according to the embodiment;

FIG. 14 is an exemplary view for explaining an example of duration adjustment of connection mode switching based on power supply states in the electronic device according to the embodiment;

FIG. 15 is an exemplary view for explaining an example for adjusting a duration assigned to an electronic device in an Initiator mode according to the embodiment using a variable value based on a random number;

FIG. 16 is an exemplary view for explaining an example for adjusting a duration assigned to an electronic device in an Initiator mode according to the embodiment using a fixed value; and

FIG. 17 is an exemplary flowchart showing the procedure of connection mode switching processing using durations based on random numbers and power supply states in the electronic device according to the embodiment.

### DETAILED DESCRIPTION

Various embodiments according to the invention will be described hereinafter with reference to the accompanying drawings. In general, according to one embodiment of the invention, there is provided an electronic device comprising: a close proximity wireless transfer device configured to execute a close proximity wireless transfer; and a connection mode switching module configured to alternately switch, when the close proximity wireless transfer device is not connected to another close proximity wireless transfer device, a connection mode of the close proximity wireless transfer device between a first mode that requests connection to the other close proximity wireless transfer device and a second mode that detects a connection request from the other close proximity wireless transfer device.

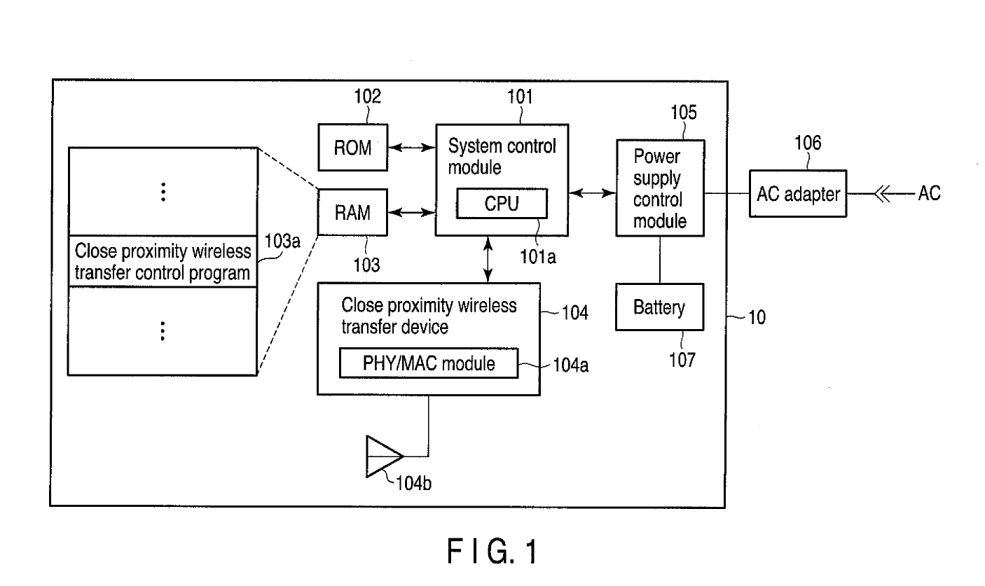

The arrangement of an electronic device 10 according to one embodiment of the present invention will be described first with reference to FIG. 1. This electronic device 10 is implemented as, for example, a portable terminal device such as a portable phone or PDA, a personal computer, or a consumer device such as a TV or audio player. This electronic device 10 includes a system control module 101, ROM 102, RAM 103, close proximity wireless transfer device 104, power supply control module 105, AC adapter 106, and battery 107.

The system control module 101 controls the operations of respective modules of the electronic device 10. The system control module 101 comprises a CPU 101a, and is connected to the ROM 102, RAM 103, close proximity wireless transfer device 104, and power supply control module 105.

The CPU 101a loads instructions and data stored in the ROM 102 onto the RAM 103, and executes required processes. On the RAM 103, a close proximity wireless transfer control program 103a used to make a close proximity wireless transfer is loaded. The CPU 101a executes the close proximity wireless transfer control program 103a loaded on the RAM 103 to control the close proximity wireless transfer device 104.

The close proximity wireless transfer device 104 executes a close proximity wireless transfer. The close proximity wireless transfer is a kind of near-field communication (NFC). The close proximity wireless transfer between the close proximity wireless transfer device and another close proximity wireless transfer device is executed in peer-to-peer. A possible communication range is, for example, 3 cm. Wireless connection between the close proximity wireless transfer device 104 and another close proximity wireless transfer device can be established only when they are brought close to each other so that their separation falls within a predetermined range (e.g., 3 cm). The close proximity wireless transfer uses an induced electric field. As the close proximity wireless transfer method, for example, Transfer JET can be used. The Transfer JET is the close proximity wireless transfer method using a UWB, and can implement high-speed data transfer.

The close proximity wireless transfer device 104 comprises a PHY/MAC module 104a and antenna module 104b. The PHY/MAC module 104a operates under the control of the close proximity wireless transfer control program 103a executed by the CPU 101a. The PHY/MAC module 104a communicates with another electronic device having a close proximity wireless transfer function via the antenna module 104b. The antenna module 104b transmits and receives data with another electronic device by means of signals using an induced electric field.

The power supply control module 105 supplies electric power to the respective modules in the electronic device 10 using electric power externally supplied via the AC adapter 106 or that supplied from the battery 107. In other words, the electronic device 10 is driven by an external power supply such as an AC commercial power supply or the battery 107. The AC adapter 106 may be arranged inside the electronic device 10. The power supply control module 105 has a function of determining whether or not an external power supply is supplied to the electronic device 10 via the AC adapter 106. When the external power supply is supplied to the electronic device 10, the power supply control module 105 supplies electric power to the respective modules in the electronic device 10 using the external power supply. On the other hand, when no external power supply is supplied to the electronic device 10, the power supply control module 105 supplies electric power to the respective modules in the electronic device 10 using that of the battery 107. Furthermore, the power supply control module 105 holds information associated with the remaining capacity of the battery 107.

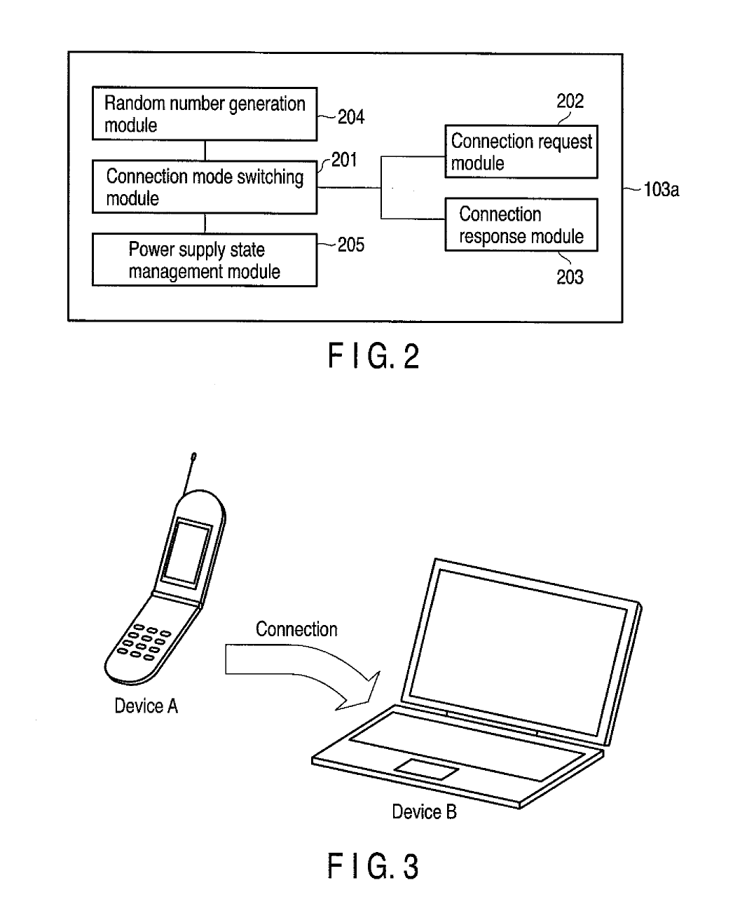

FIG. 2 shows the configuration of the close proximity wireless transfer control program 103a. The close proximity wireless transfer control program 103a comprises a connection mode switching module 201, connection request module 202, connection response module 203, random number generation module 204, and power supply state management module 205. These connection mode switching module 201, connection request module 202, connection response module 203, random number generation module 204, and power supply state management module 205 are respectively implemented as software modules.

The connection mode switching module 201 decides either one of the connection request module 202 and the connection response module 203 as a module to be operated, and selects one of the connection request module 202 and connection response module 203. One of the connection request module 202 and connection response module 203, which is selected by the connection mode switching module 201, controls the close proximity wireless transfer device 104.

Connection modes of the close proximity wireless transfer method include Initiator mode and Responder mode. A device set in Initiator mode, i.e., an Initiator, serves as a master device, and transmits a connection request to another device. A device set in Responder mode, i.e., a Responder, serves as a slave device, and detects the connection request transmitted from the Initiator. In the close proximity wireless transfer method, when the Initiator and Responder are brought close to each other, connection between these Initiator and Responder is established. Even when the Responders or Initiators are brought close to each other, communication cannot be established. For this reason, in order to execute a data transfer between devices using the close proximity wireless transfer, the user needs to make an operation for setting the connection modes of these devices. However, such operation is troublesome for the user.

The connection mode switching module 201 executes control to automatically switch Initiator mode and Responder mode so as to establish connection between the close proximity wireless transfer device 104 and another close proximity wireless transfer device without any user's operation associated with a change of the connection mode. As described above, in Initiator mode, the close proximity wireless transfer device 104 issues a connection request to another close proximity wireless transfer device to be connected. On the other hand, in Responder mode, the close proximity wireless transfer device 104 detects a connection request from another close proximity wireless transfer device to be connected. Therefore, the connection request module 202 executes processing corresponding to Initiator mode. Also, the connection response module 203 executes processing corresponding to Responder mode.

The connection request module 202 transmits a connection request signal “Connect” (Connect signal) to another close proximity wireless transfer device to be connected via the close proximity wireless transfer device 104.

Responder mode of the connection response module 203 is further divided into two modes, i.e., Search mode and Sleep mode. In Search mode, the connection response module 203 checks whether a Connect signal is reached from another close proximity wireless transfer device in Initiator mode. In Sleep mode, the connection response module 203 reduces power consumption by suppressing communication. That is, in Sleep mode, Search processing for detecting a Connect signal is not executed.

The connection mode switching module 201 alternately switches the connection mode of the close proximity wireless transfer device 104 between Initiator mode and Responder mode, as described above. This connection mode switching processing can raise the probability of establishing connection between the electronic device 10 and another electronic device. This is for the following reason.

The connection mode can also be switched in response to a user's explicit instruction such as a button operation. For example, assume that two devices A and B exist. The default connection mode of each of these devices A and B is set to be Responder mode. In Responder mode, each device executes Search processing at given time intervals. When the user operates device A, the connection mode of device A is switched from Responder mode to Initiator mode. Device B in Responder mode executes Search processing at given time intervals. Therefore, when the user brings device A close to device B, device B can detect a Connect signal transmitted from device A.

However, the operation required to switch the connection mode is troublesome for the user, as described above. FIG. 3 shows an example of the close proximity wireless transfer using the electronic device 10 of this embodiment. Assume that of two devices A and B, device A is the close proximity wireless transfer device 104 arranged in the electronic device 10 of this embodiment, and device B is another close proximity wireless transfer device set in Responder mode. In this case, in device A, the connection mode switching module 201 alternately switches the connection mode between Initiator mode and Responder mode. Device B executes Search processing at given time intervals. When the connection mode switching module 201 switches the connection mode of device A to Initiator mode, device B in Responder mode executes the Search processing at given time intervals. Therefore, as in the case in which the user makes an operation for explicitly switching the connection mode of device A, when the user brings device A close to device B, device B can detect a Connect signal transmitted from device A.

Note that FIG. 3 illustrates device A as a portable phone and device B as a personal computer. However, a combination of electronic devices that make a close proximity wireless transfer is not limited to such specific combination. Therefore, any of devices which can implement this embodiment such as a portable phone, personal computer, and various consumer devices, and the like may be combined.

The connection mode switching module 201 decides a period (time interval) assigned to the connection mode using information obtained from the random number generation module 204 and power supply state management module 205 upon setting the connection mode as one of Initiator mode and Responder mode in the close proximity wireless transfer device 104. The random number generation module 204 outputs a generated random number to the connection mode switching module 201. The power supply state management module 205 holds information associated with the presence or absence of an external power supply via the AC adapter 106, and that associated with the remaining capacity of the battery 107, which are obtained from the power supply control module 105.

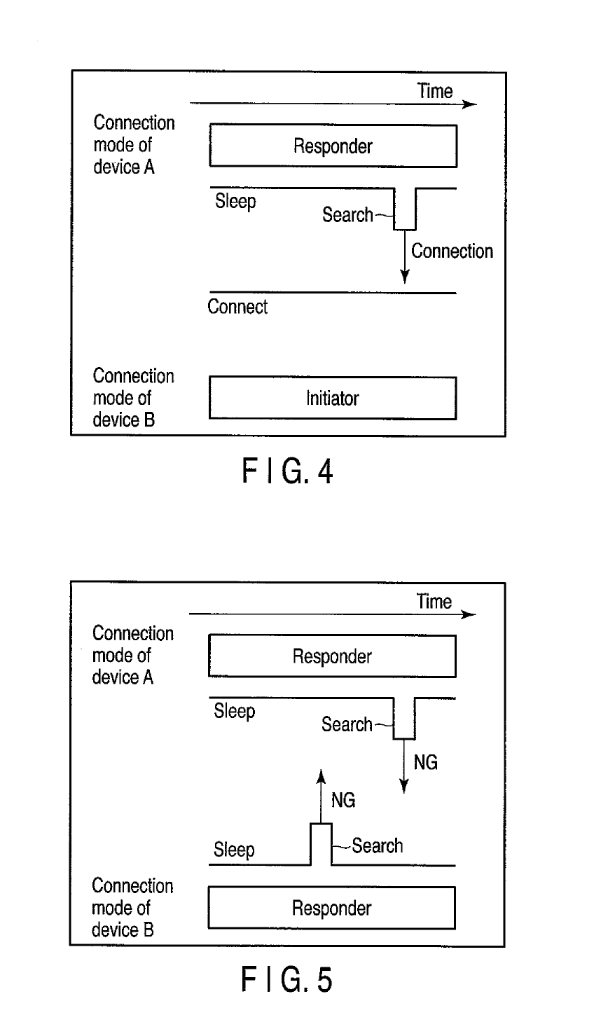

FIG. 4 shows connection processing between two electronic devices based on a normal close proximity wireless transfer method. Note that device A is in Responder mode, and responds to a connection request from device B during a period in which Search processing is executed. On the other hand, device B is in Initiator mode, and transmits a connection request to device A.

In FIG. 4, device B transmits a Connect signal to device A. During Sleep mode, device A does not communicate, and does not respond to a connection request from device B. When device A transits from Sleep mode to Search mode, device A executes the Search processing, and detects the Connect signal from device B. Therefore, device A detects the Connect signal from device B during Search mode of device A, and connection between devices A and B is established.

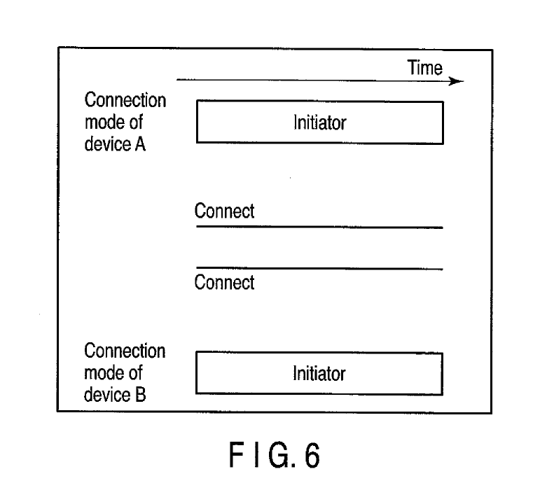

By contrast, FIGS. 5 and 6 show examples in which connection processing based on the normal close proximity wireless transfer method fails between the two electronic devices.

In FIG. 5, both devices A and B operate in Responder mode. Since neither device A nor device B is in Initiator mode, they do not transmit any Connect signal. Therefore, neither device A nor device B detects a Connect signal from another electronic device during Search mode period, and connection cannot be established.

In FIG. 6, both devices A and B operate in Initiator mode, and transmit Connect signals. However, since neither device A nor device B is in Responder mode, they do not detect a connection request in Search mode. Therefore, since there is no electronic device which responds to their Connect signals, devices A and B cannot establish connection.

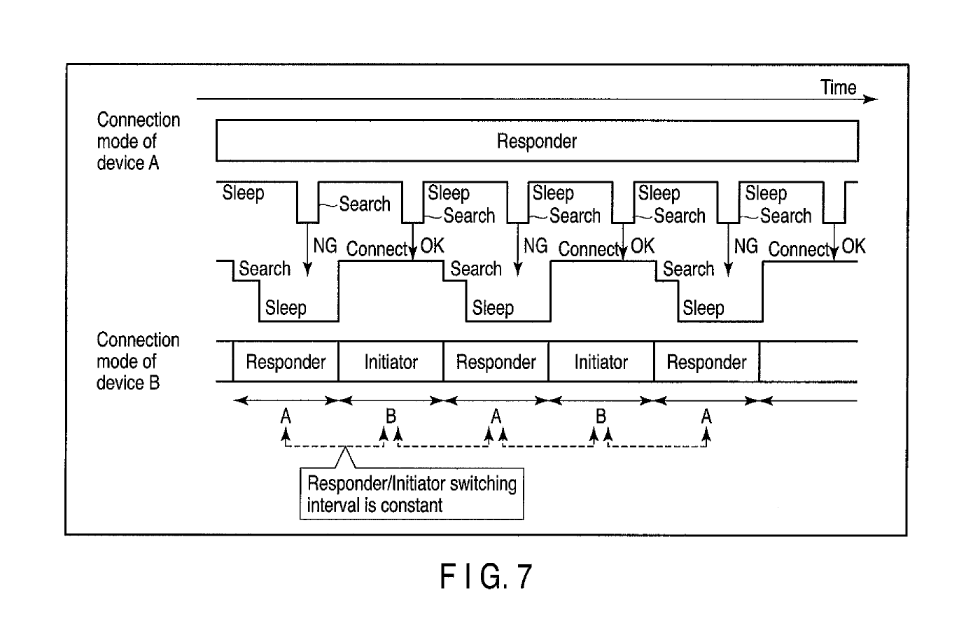

FIG. 7 shows connection mode switching processing upon making a close proximity wireless transfer between two electronic devices in this embodiment. Note that device A is a close proximity wireless transfer device in Responder mode. On the other hand, device B is the close proximity wireless transfer device 104 arranged in the electronic device 10 of this embodiment. Device B alternately switches the connection mode between Initiator mode and Responder mode using the connection mode switching module 201. In this case, since device A is in Responder mode, if device B is always set in Initiator mode, connection between these devices can be easily established. However, the power consumption of a device in Initiator mode is large, and it is difficult to always set device B in Initiator mode in practical use. Assuming use in a portable terminal device such as a portable phone or the like, it is desired to reduce power consumption as much as possible for the purpose of long-term, continuous use. Hence, in this embodiment, the connection mode is alternately switched between Responder mode that requires small power consumption and Initiator mode that requires large power consumption. In FIG. 7, in device B, a constant duration as period A is assigned to Responder mode, and that as period B is assigned to Initiator mode. On the other hand, device A executes Search processing at given time intervals.

In this way, by switching the connection mode set in the close proximity wireless transfer device 104 of device B, connection between devices A and B can be established without any user's explicit operation for switching the connection mode. For example, when data saved in a portable phone and the backup of the data stored in a personal computer are to be synchronized, the user need only bring the portable phone close to the personal computer.

In FIG. 7, when device A in Responder mode is executing Search processing during a period in which device B transmits a Connect signal (during Initiator mode), connection can be established (OK). On the other hand, even when device A in Responder mode executes Search processing during Responder mode of device B, no connection is established (NG) as in the example shown in FIG. 5.

In FIG. 7, assume that Search mode of device A has the switching timings between Sleep mode and Search mode (to be referred to as Sleep/Search mode switching timings hereinafter), which match only NG periods in FIG. 7. The Sleep/Search mode switching timings are synchronized with the Initiator/Responder mode switching timings (the switching timing between periods A as Responder mode and periods B as Initiator mode). In such case, a situation in which when device A executes Search processing, device B is always in Responder mode, occurs. That is, if these two switching timings are synchronized, the following phenomenon is likely to occur. That is, device B never transmits a Connect signal during a period in which device A executes Search processing, and connection cannot always be established.

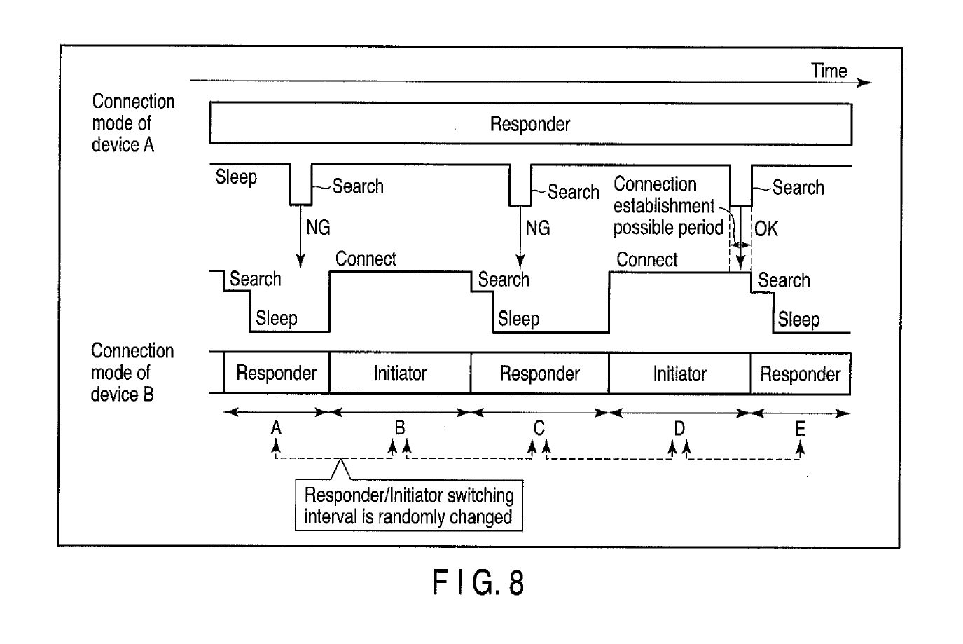

Hence, in this embodiment, the connection mode switching module 201 generates a random number, and switches between Initiator mode and Responder mode at time intervals (periods) which change according to this random number. FIG. 8 shows connection mode switching processing using periods based on the generated random number. In this case, device A is a close proximity wireless transfer device in Responder mode. On the other hand, device B is the close proximity wireless transfer device 104 arranged in the electronic device 10 of this embodiment. Device B alternately switches the connection mode between Initiator mode and Responder mode using the connection mode switching module 201. In device B, periods respectively assigned to Responder mode and Initiator mode are decided based on random numbers generated by the random number generation module 204 at respective switching timings. Therefore, the periods assigned to Responder mode and Initiator mode are randomly changed at respective switching timings.

In FIG. 8, periods assigned to respective connection modes upon switching between Responder mode and Initiator mode of device B are randomly changed at respective switching timings such as periods A, B, C, D, E, . . . . As a result, since the Initiator/Responder mode switching timings of device B can be prevented from being synchronized with the Sleep/Search mode switching timings of device A in Responder mode, connection between the devices can be normally established.

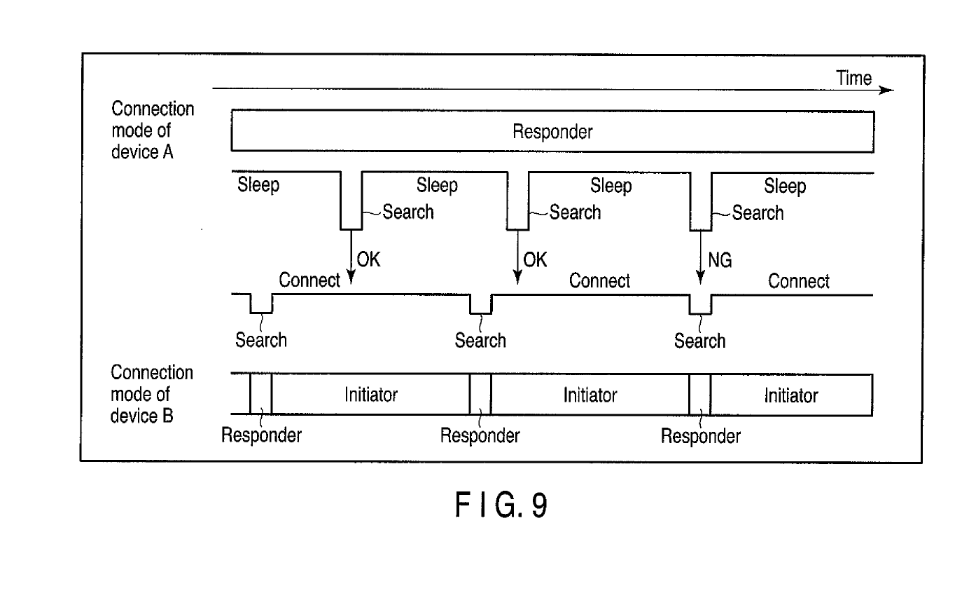

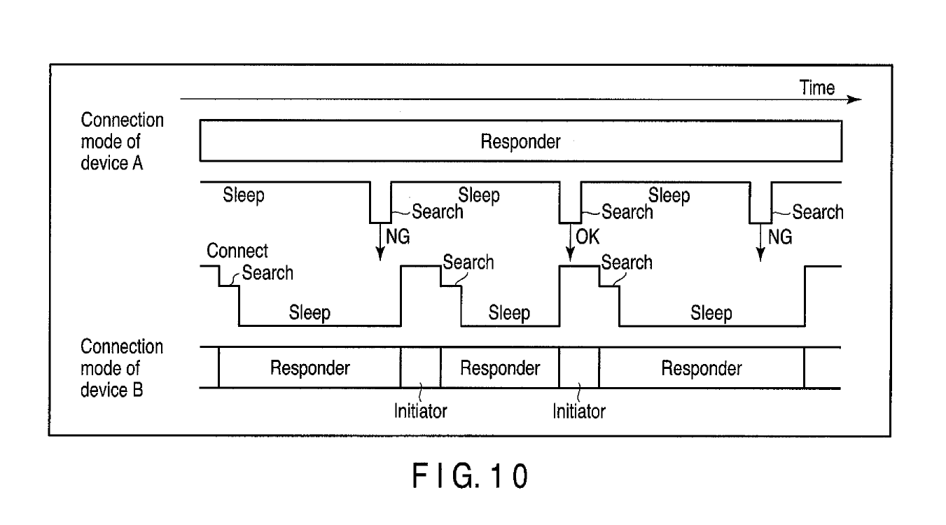

As described above, assuming use in a portable terminal device such as a portable phone or the like, it is desired to reduce the power consumption as much as possible for the purpose of long-term, continuous use. Hence, in this embodiment, the connection mode switching periods can also be adjusted based on the power supply states, as shown in FIGS. 9 and 10.

In this case, each period in which the close proximity wireless transfer device 104 is maintained in Initiator mode when the electronic device 10 is driven by the external power supply is set to be longer than that in which the close proximity wireless transfer device 104 is maintained in Initiator mode when the electronic device 10 is not driven by the external power supply (when it is driven by the battery 107). Conversely, each period in which the close proximity wireless transfer device 104 is maintained in Responder mode when the electronic device 10 is driven by the external power supply is set to be shorter than that in which the close proximity wireless transfer device 104 is maintained in Responder mode when the electronic device 10 is not driven by the external power supply.

As a result, when the electronic device 10 is driven by the external power supply, although electric power consumed by the close proximity wireless transfer device 104 increases, connection between the devices can be successfully established more easily within a shorter period. On the other hand, when the electronic device 10 is not driven by the external power supply, electric power consumed by the close proximity wireless transfer device 104 can be reduced.

Even when the electronic device 10 is driven by the battery 107, if the remaining capacity of the battery 107 is greater than or equal to a threshold, each period in which the close proximity wireless transfer device 104 is maintained in Initiator mode may be set to be a long period equal to the duration of the period in which the close proximity wireless transfer device 104 is maintained in Initiator mode when the electronic device 10 is driven by the external power supply. As the threshold, for example, a value indicating the remaining capacity of the battery 107 corresponding to a state in which the battery 107 is nearly fully charged can be used. When the electronic device 10 is driven by the battery 107 and the remaining capacity of the battery 107 is less than the threshold, each period in which the close proximity wireless transfer device 104 is maintained in Initiator mode is set to be shorter than that in which the close proximity wireless transfer 104 is maintained in Initiator mode when the electronic device 10 is driven by the external power supply or when the remaining capacity of the battery 107 is greater than or equal to the threshold.

FIG. 9 shows the connection mode switching processing when the electronic device 10 is connected to the external power supply via the AC adapter 106 or when the power capacity is sufficiently large (e.g., when the battery 107 is fully charged). In this case, device A is a close proximity wireless transfer device in Responder mode. In device A, Search processing is executed at constant time intervals. On the other hand, device B is the close proximity wireless transfer device 104 arranged in the electronic device 10 of this embodiment. Device B alternately switches the connection mode between Initiator mode and Responder mode using the connection mode switching module 201. Note that Responder mode of device B includes only Search mode, and is not switched to Sleep mode. Hence, in device B, the connection mode switching module 201 executes switching between Initiator mode for a long duration and Responder mode (Search mode) for a short duration. With this switching processing, the Search processing period of device A is more likely to overlap the Connect signal transmission period by device B. That is, connection between devices is easily successfully established within a shorter period.

However, since no Sleep mode is executed in device B, the power consumption is large. Therefore, this connection mode switching processing can be executed only when the electronic device is connected to the external power supply or when the power capacity is sufficiently large (e.g., when the battery is fully charged), as described above.

By contrast, FIG. 10 shows the connection mode switching processing when the remaining capacity of the battery 107 of the electronic device 10 is small. In this case as well, device A is a close proximity wireless transfer device in Responder mode. Device A executes Search processing at given time intervals. On the other hand, device B is the close proximity wireless transfer device 104 arranged in the electronic device 10 of this embodiment. Device B alternately switches the connection mode between Initiator mode and Responder mode using the connection mode switching module 201. Note that device B sets long Responder mode periods, and short Initiator mode periods. In this way, the switching processing that sets each Responder mode period with small power consumption to be longer than the Initiator mode period can reduce the power consumption.

As described above, each Initiator mode period shown in FIG. 9 when the electronic device 10 is connected to the external power supply or when the remaining capacity of the battery 107 is greater than or equal to the threshold is set to be longer than that shown in FIG. 10 when the remaining capacity of the battery 107 is less than the threshold. That is, when the power capacity is sufficiently large, although the power consumption is large, the connection mode switching processing that can easily successfully establish connection between the devices within a shorter period is executed, as shown in FIG. 9. On the other hand, when the power capacity is insufficient, the connection mode switching processing that can reduce the power consumption is executed, as shown in FIG. 10.

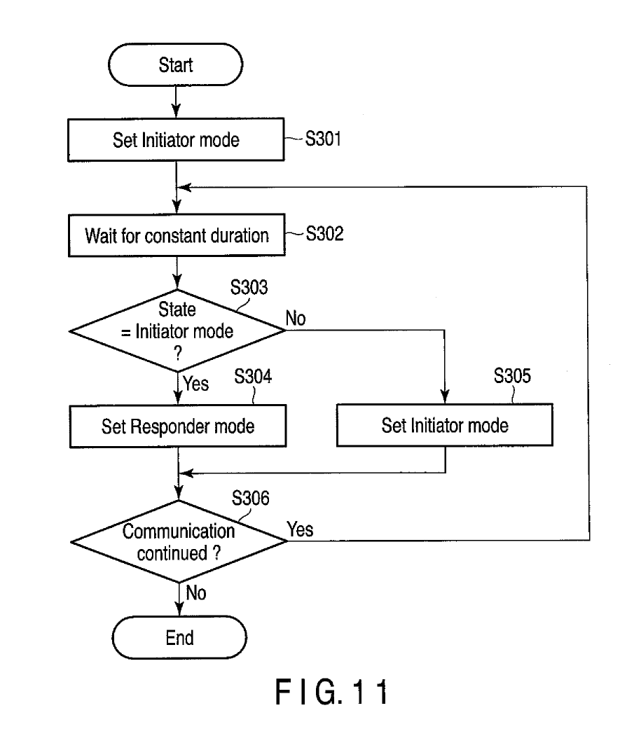

The connection mode switching processing for switching the connection mode at given time intervals is described below with reference to the flowchart shown in FIG. 11. In the following description, a period in which the connection mode switching module 201 sets the close proximity wireless transfer device 104 in Initiator mode will be referred to as an Initiator duration, and a period in which the module 201 sets the device 104 in Responder mode will be referred to as a Responder duration.

The connection mode switching module 201 sets the connection mode of the close proximity wireless transfer device 104 in, e.g., Initiator mode (block S301).

The close proximity wireless transfer device 104 waits for a given duration set in advance with respect to the set mode (block S302). That is, when Initiator mode is set, the close proximity wireless transfer device 104 requests connection to another close proximity wireless transfer device during only the Initiator duration, which is set in advance for Initiator mode. On the other hand, when Responder mode is set, the close proximity wireless transfer device 104 responds to a connection request from another close proximity wireless transfer device during only a Search processing duration in the Responder duration, which is set in advance for Responder mode.

After waiting for the given duration, the connection mode switching module 201 checks whether the connection mode of the close proximity wireless transfer device 104 is Initiator mode (block S303). If the connection mode is Initiator mode (Yes in block S303), the connection mode switching module 201 switches the connection mode of the close proximity wireless transfer device 104 to Responder mode (block S304). If the connection mode is not Initiator mode, i.e., if the connection mode is Responder mode (No in block S303), the connection mode switching module 201 switches the connection mode of the close proximity wireless transfer device 104 to Initiator mode (block S305).

The connection mode switching module 201 checks whether the electronic device 10 continues communication using the close proximity wireless transfer device 104 (block S306). If the electronic device 10 continues a close proximity wireless transfer (Yes in block S306), the connection mode switching module 201 repeats the processes in block 5302 and the subsequent blocks. If the electronic device 10 does not continue a close proximity wireless transfer (No in block S306), the connection mode switching module 201 ends the processing.

With the aforementioned processing, the connection mode switching processing that switches the connection mode at given time intervals, as shown in FIG. 7, is implemented.

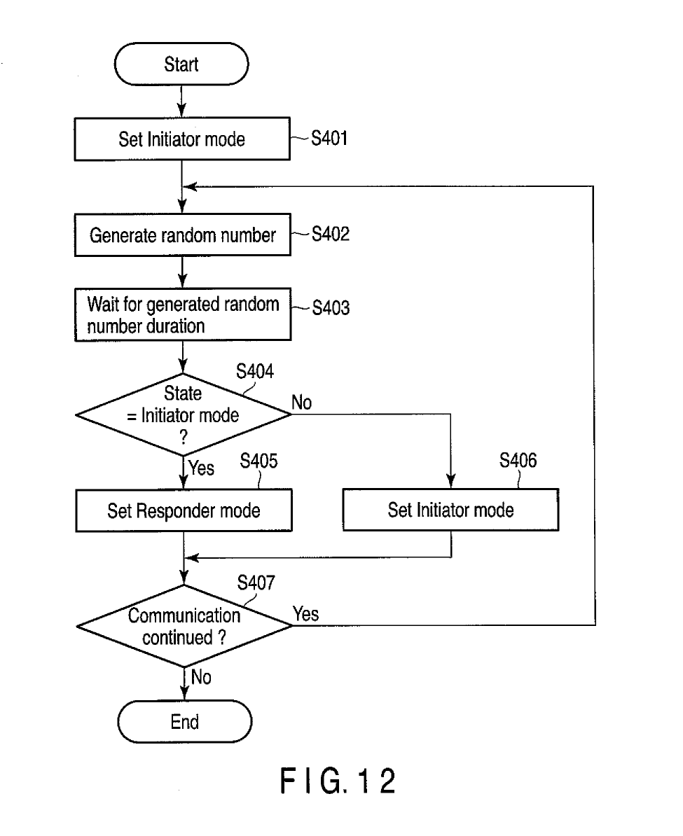

By contrast, FIG. 12 is a flowchart of the connection mode switching processing that switches the connection modes at periods (time intervals) decided based on random numbers generated at respective switching timings.

The connection mode switching module 201 sets the connection mode of the close proximity wireless transfer device 104 in, e.g., Initiator mode (block S401).

The connection mode switching module 201 receives a random number generated by the random number generation module 204 from the random number generation module 204 (block S402). The connection mode switching module 201 sets the value of the received random number as a time interval, and waits switching for this random number duration (block S403). That is, when the connection mode is set in Initiator mode, the close proximity wireless transfer device 104 requests connection to another electronic device during only this random number duration. When the connection mode is set in Responder mode, the close proximity wireless transfer device 104 responds to a connection request from another electronic device during only this random number duration.

Next, the connection mode switching module 201 checks whether the connection mode of the close proximity wireless transfer device 104 is Initiator mode (block S404). If the connection mode is Initiator mode (Yes in block S404), the connection mode switching module 201 switches the connection mode to Responder mode (block S405). If the connection mode is not Initiator mode, i.e., if the connection mode is Responder mode (No in block S404), the connection mode switching module 201 switches the connection mode to Initiator mode (block S406).

The connection mode switching module 201 checks whether the electronic device 10 continues communication using the close proximity wireless transfer device 104 (block S407). If the electronic device 10 continues a close proximity wireless transfer (Yes in block S407), the connection mode switching module 201 repeats the processes in block 5402 and the subsequent blocks. If the electronic device 10 does not continue a close proximity wireless transfer (No in block S407), the connection mode switching module 201 ends the processing.

With the aforementioned processing, the connection mode switching processing that switches the connection mode at time intervals based on the random numbers generated at respective switching timings, as shown in FIG. 8, is implemented. As a result, since the connection mode switching timing of the electronic device 10 is randomly changed, the Initiator/Responder mode switching timings of the electronic device 10 can be prevented from being synchronized with the Sleep/Search mode switching timings of another electronic device in Responder mode. Therefore, connection between the electronic device 10 and another electronic device can be normally established.

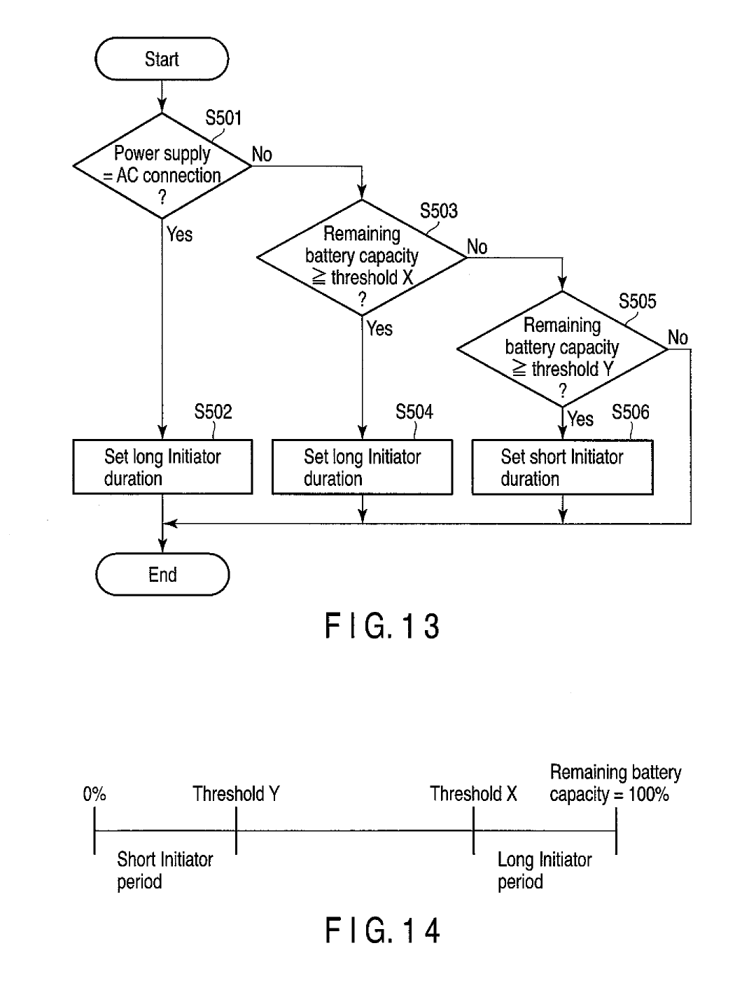

FIG. 13 is a flowchart of processing for adjusting the connection mode switching timings according to the power supply state of the electronic device 10. The connection mode switching module 201 adjusts the connection mode switching timings based on information associated with the power supply state of the electronic device 10, which is held by the power supply state management module 205.

The connection mode switching module 201 checks whether the electronic device 10 is connected to an AC power supply (block S501). If the electronic device 10 is connected to the AC power supply, i.e., if the electronic device 10 is driven by the external power supply (Yes in block S501), the connection mode switching module 201 sets each Initiator duration as a period in which the close proximity wireless transfer device 104 of the electronic device 10 operates in Initiator mode to be long (block S502).

If the electronic device 10 is not connected an AC power supply, i.e., if the electronic device 10 is driven by the battery 107 (No in block S501), the connection mode switching module 201 executes processing according to the remaining capacity of the battery 107. If the remaining capacity of the battery 107 is greater than or equal to a threshold X (Yes in block S503), the connection mode switching module 201 sets a long Initiator duration (block S504). If the remaining capacity of the battery 107 is not greater than or equal to the threshold X (No in block S503), and if the remaining capacity of the battery 107 is less than or equal to a threshold Y (Yes in block S505), the connection mode switching module 201 sets a short Initiator duration (block S506). If the remaining capacity of the battery 107 is not greater than or equal to the threshold X (No in block S503), and if the remaining capacity of the battery 107 is not less than or equal to the threshold Y (No in block S505), the Initiator duration remains unchanged. In this case, assume that threshold X> threshold Y.

Therefore, the connection mode switching module 201 sets the Initiator duration based on the power supply state of the electronic device 10, as shown in FIG. 14. That is, when the electronic device 10 is connected to the AC power supply or when the remaining capacity of the battery 107 is greater than or equal to the threshold X, the module 201 sets the Initiator duration to be longer than the Responder duration. When the remaining capacity of the battery 107 is less than or equal to the threshold Y, the module 201 sets the Initiator duration to be shorter than the Responder duration. When the remaining capacity of the battery 107 is greater than the threshold Y and is less than the threshold X, the Initiator duration remains unchanged. As described above, when the electronic device 10 is driven by the AC power supply, or when it is driven by the battery 107 and the remaining capacity of the battery 107 is greater than or equal to the threshold X, the Initiator duration is set to be longer than that when the electronic device 10 is driven by the battery 107 and the remaining capacity of the battery 107 is less than or equal to the threshold Y. Note that the example using two thresholds, i.e., the thresholds X and Y has been explained in this case. Alternatively, only one threshold may be used.

With the aforementioned processing, the connection mode switching processing that switches the connection mode at periods decided based on the power supply state of the electronic device 10, as shown in FIGS. 9 and 10, is implemented. That is, when the electronic device 10 is connected to the AC power supply or when the remaining capacity of the battery 107 is sufficiently large, the Initiator duration and Responder duration are changed to enhance the possibility of connection between the electronic device 10 and another electronic device. On the other hand, when the remaining capacity of the battery 107 is insufficient, the Initiator duration and Responder duration are changed to reduce the power consumption required to operate the close proximity wireless transfer device 104.

Note that FIGS. 13 and 14 show the example of the connection mode switching timing adjustment based on the power supply state, and the present invention is not limited to such specific connection mode switching timing adjustment method. FIGS. 13 and 14 show the method of setting the Initiator duration while dividing into three stages based on the power supply states. However, the number of divisions and the thresholds for division can be changed according to the type of usage and the like of the electronic device 10. Also, the Initiator duration may be calculated by setting a calculation formula based on the remaining battery capacity.

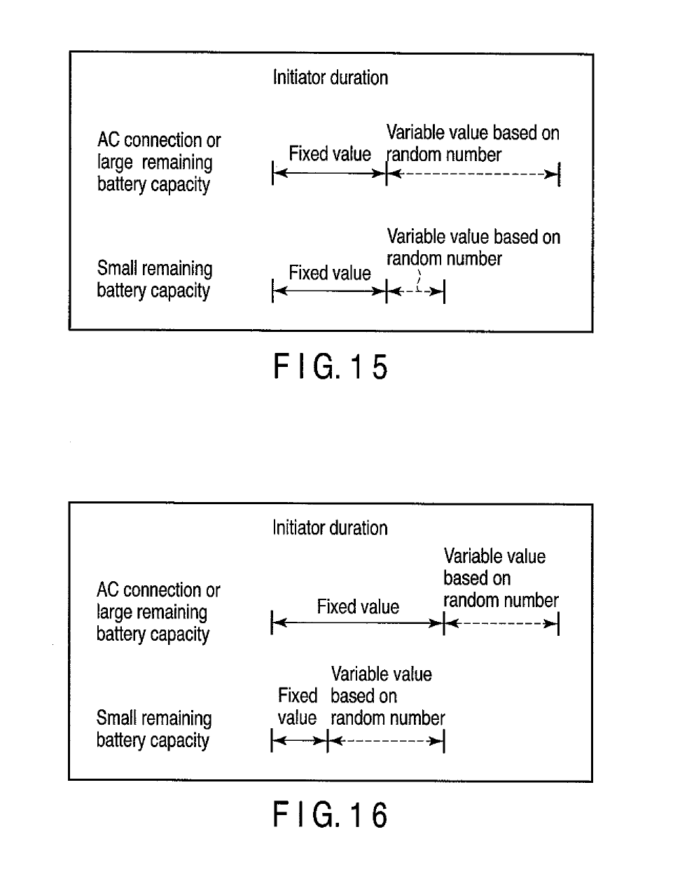

FIGS. 15 and 16 show examples of Initiator duration calculations based on the power supply states of the electronic device 10. The Initiator duration can be calculated by a value obtained by adding a fixed value which is given in advance, and a variable value based on a random number generated by the random number generation module 204.

In the example shown in FIG. 15, a value that the random number generated by the random number generation module 204 can assume is changed according to the power supply states, and is set as a variable value, thereby adjusting the Initiator duration. The fixed value is set to be constant irrespective of the power supply states.

More specifically, when the electronic device 10 is connected to the AC power supply or when the remaining battery capacity is large, a large maximum value that the random number generated by the random number generation module 204 can assume is set. On the other hand, when the remaining battery capacity of the electronic device 10 is small, a small maximum value that the random number generated by the random number generation module 204 can assume is set. As a result, when the electronic device 10 is connected to the AC power supply or when the remaining battery capacity is large, a long Initiator duration is set. On the other hand, when the remaining battery capacity is small, a short Initiator duration is set.

In the example shown in FIG. 16, since the fixed value is changed according to the power supply states, the Initiator duration is adjusted. As for the variable value, a value range that the random number generated by the random number generation module 204 can assume is set to be constant irrespective of the power supply states.

More specifically, when the electronic device 10 is connected to the AC power supply or when the remaining battery capacity is large, a large fixed value is set. On the other hand, when the remaining battery capacity of the electronic device 10 is small, a small fixed value is set. As a result, when the electronic device 10 is connected to the AC power supply or when the remaining battery capacity is large, a long Initiator duration is set. On the other hand, when the remaining battery capacity is small, a short Initiator duration is set.

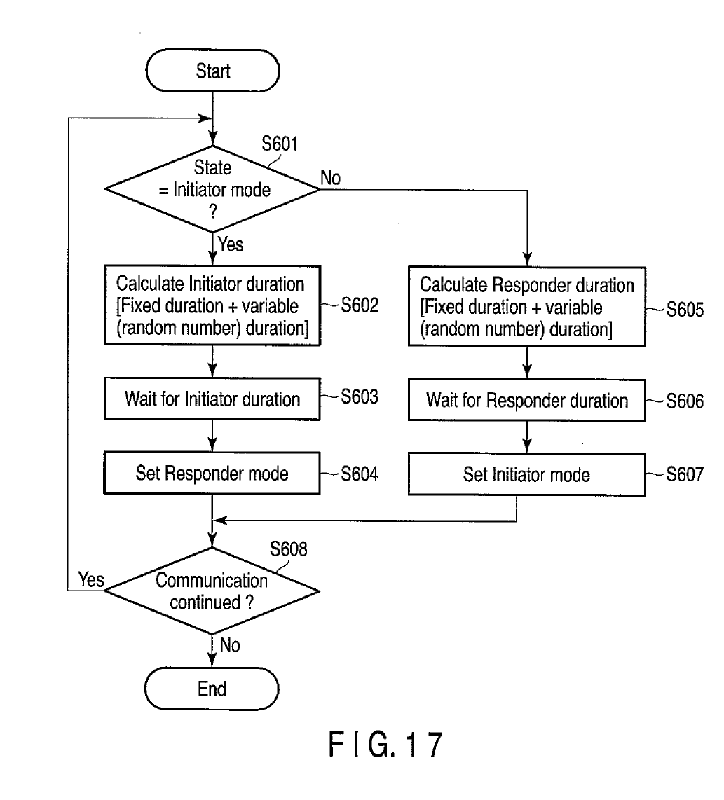

FIG. 17 is a flowchart of the connection mode switching processing that switches the connection mode at periods based on the random numbers generated at respective switching timings and the power supply states of the electronic device 10.

The connection mode switching module 201 checks whether the connection mode of the close proximity wireless transfer device 104 is Initiator mode (block S601).

If the connection mode of the close proximity wireless transfer device 104 is Initiator mode (Yes in block S601), the connection mode switching module 201 executes the following processes in blocks 5602 to 5604. The connection mode switching module 201 calculates the Initiator duration first (block S602). As the Initiator duration, as in the example shown in FIGS. 15 and 16, a value obtained by adding a variable duration decided based on a random number generated by the random number generation module 204 to a fixed duration decided based on the connection mode and the power supply state is set.

Next, the connection mode switching module 201 waits switching for the Initiator duration (block S603). That is, the close proximity wireless transfer device 104 issues a connection request to another close proximity wireless transfer device during only the Initiator duration. Then, the connection mode switching module 201 switches the connection mode of the close proximity wireless transfer device 104 to Responder mode (block S604).

If the connection mode of the close proximity wireless transfer device 104 is not Initiator mode (if it is Responder mode) (No in block S601), the connection mode switching module 201 executes the following processes in blocks S605 to S607. The connection mode switching module 201 calculates the Responder duration first (block S605). As the Responder duration, as in the example shown in FIGS. 15 and 16, a value obtained by adding a variable duration decided based on a random number generated by the random number generation module 204 to a fixed duration decided based on the connection mode and the power supply state is set.

Next, the connection mode switching module 201 waits switching for the Responder duration (block S606). That is, the close proximity wireless transfer device 104 responds to a connection request from another close proximity wireless transfer device during only the Responder duration. Then, the connection mode switching module 201 switches the connection mode of the close proximity wireless transfer device 104 to Initiator mode (block S607).

After execution of the processes for each connection mode set in the close proximity wireless transfer device 104, the connection mode switching module 201 checks whether the electronic device 10 continues communication using the close proximity wireless transfer device (block S608). If the electronic device 10 continues a close proximity wireless transfer (Yes in block S608), the connection mode switching module 201 repeats the processes in block S601 and the subsequent blocks. If the electronic device 10 does not continue a close proximity wireless transfer (No in block S608), the connection mode switching module 201 ends the processing.

As described above, according to this embodiment, by switching the connection mode set in one of Initiator mode and Responder mode in the close proximity wireless transfer device arranged in the electronic device, connection between electronic devices can be easily established. Since periods (time intervals) in which the connection mode is assigned as Initiator mode and Responder mode are decided based on random numbers generated at respective switching timings and the power supply states of the electronic device, connection with another electronic device can be surely established. In addition, by controlling connection according to the power supply states, the power consumption required for a close proximity wireless transfer can be reduced.

Note that the connection mode switching module 201, connection request module 202, connection response module 203, random number generation module 204, and power supply state management module 205 in FIG. 2 described as software modules in this embodiment may be implemented as hardware modules.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a close proximity wireless transfer device configured to execute a close proximity wireless transfer; and
a connection mode switching module configured to switch a connection mode of the close proximity wireless transfer device between a first mode in which the close proximity wireless transfer device is configured to request a connection to a second close proximity wireless transfer device and consumes a first power, and a second mode in which the close proximity wireless transfer device is configured to detect a connection request from the second close proximity wireless transfer device and consumes a second power which is smaller than the first power, when the close proximity wireless transfer device is not connected to the second close proximity wireless transfer device,
wherein the connection mode switching module is configured to set the connection mode to the first mode in preference to the second mode when the electronic device is driven by an external power source, in comparison with the case of the electronic device being not driven by the external power source, to generate a random number when switching the connection mode, and to set a period in which the connection mode is kept using the random number.

2. The electronic device of claim 1, wherein the connection mode switching module is configured to set each period in which the connection mode is kept in the first mode when the electronic device is driven by the external power source to be longer than each period in which the connection mode is kept in the first mode when the electronic device is not driven by the external power source.

3. The electronic device of claim 1, wherein the connection mode switching module is configured to set each period in which the connection mode is kept in the first mode when the electronic device is driven by a battery in the electronic device to be shorter than each period in which the connection mode is kept in the first mode when the electronic device is driven by the external power source.

4. An electronic device comprising:
a close proximity wireless transfer device configured to execute a close proximity wireless transfer; and
a connection mode switching module configured to switch, when the close proximity wireless transfer device is not connected to another close proximity wireless transfer device a connection mode of the close proximity wireless transfer device between a first mode in which connection to said another close proximity wireless transfer device is requested and a first power is consumed, and a second mode in which a connection request from said another close proximity wireless transfer device is detected and a second power, which is smaller than the first power, is consumed,
wherein the connection mode switching module is configured to determine whether a remaining capacity of a battery is not less than a threshold when the electronic device is driven by the battery in the electronic device,
when the determination shows that the remaining capacity of the battery is not less than the threshold, the connection mode switching module is configured to switch the connection mode to the first mode in preference to the second mode selected when the remaining capacity of the battery is less than the threshold,
when the determination shows that the remaining capacity of the battery is less than the threshold, the connection mode switching module is configured to switch the connection mode to the second mode in preference to the first mode selected when the remaining capacity of the battery is not less than the threshold, and
wherein the connection mode switching module is configured to generate a random number when switching the connection mode, and to set a period in which the connection mode is kept using the random number.

5. The electronic device of claim 4, wherein the connection mode switching module is configured to set each period in which the connection mode is kept in the first mode when the electronic device is driven by an external power supply to be longer than each period in which the connection mode is kept in the first mode when the electronic device is driven by the battery.

6. The electronic device of claim 4, wherein the connection mode switching module is configured to determine whether a remaining capacity of the battery is not less than a threshold when the electronic device is driven by the battery in the electronic device,
when the determination shows that the remaining capacity of the battery is not less than the threshold, the connection mode switching module is configured to set each period in which the connection mode is kept in the first mode to be longer than each period in which the connection mode is kept in the first mode when the remaining capacity of the battery is less than the threshold, and
when the remaining capacity of the battery is less than the threshold, the connection mode switching module is configured to set each period in which the connection mode is maintained in the second mode to be longer than each period in which the connection mode is maintained in the second mode when the remaining capacity of the battery is not less than the threshold.

7. A communication control method for an electronic device that comprises a close proximity wireless transfer device comprising:
executing a close proximity wireless transfer using the close proximity wireless transfer device and
switching a connection mode of the close proximity wireless transfer device between a first mode in which the close proximity wireless transfer device is configured to request connection to a second close proximity wireless transfer device and consumes a first power, and a second mode in which the close proximity wireless transfer device is configured to detect a connection request from the second close proximity wireless transfer device and consumes a second power which is smaller than the first power, when the close proximity wireless transfer device is not connected to the second close proximity wireless transfer device,
wherein the switching includes setting the connection mode to the first mode in preference to the second mode when the electronic device is driven by an external power source, in comparison with the case of the electronic device being not driven by the external power source, generating a random number when switching the connection mode, and setting a period in which the connection mode is kept using the random number

8. The electronic device of claim 1, wherein the connection mode switching module is configured to set each period in which the connection mode is kept in the first mode to be longer than each period in which the connection mode is kept in the second mode when the electronic device is driven by the external power source.
